(19) United States
(12) Patent Application Publication
(10) Pub. No.: US 2010/0297317 A1
(43) Pub. Date: Nov. 25, 2010

(54) METHOD AND SYSTEM FOR AN EDIBLE SERVING DISH MADE OF BAKED COOKIE

(76) Inventor: Mark Valerius, Frankfort, IL (US)

Correspondence Address: Larry E Severin, Esq, 3581 Teaberry Circle, Seal Beach, CA, 90740, US

(21) Appl. No.: 12/783,497

(22) Filed: May 19, 2010

Related U.S. Application Data
(60) Provisional application No. 61/179,431, filed on May 19, 2009.

(51) Int. Cl. A23P 1/10; A23P 1/00; A21D 13/00

(52) U.S. Cl. 426/391; 99/450.1

(57) ABSTRACT

A method of making an edible serving dish made of baked cookie includes forming a dough into a disk; cooling the disk of dough so that the disk generally maintains its shape; placing the disk on a mold; and baking the disk and mold, so that some of the dough flows down the sides of the mold, thereby forming a bowl

### RELATED APPLICATIONS

This application claims the benefit of the filing date of U.S. patent application Ser. No. 61/179,431, filed May 19, 2009, which is incorporated herein by reference in its entirety.

### BACKGROUND OF THE INVENTION

The present invention generally relates to food and, more specifically, to an edible serving dish made of baked cookie and a method for making same.

People who wish to eat their ice cream or other treats in an edible serving dish composed of a baked cookie as well as businesses who wish to produce, manufacture or serve their ice cream and food products in an edible serving bowl composed of a baked cookie do not have enough options available to economically produce a cookie bowl.

Current methods may produce a serving dish composed of a baked cookie, but require specialty machinery not readily or economically available.

Current methods may produce a serving dish composed of a baked cookie utilizing specialty machinery, and produce a cookie that appears to have two bottoms in that both sides (interior and exterior) of the bowl have a flattened “baked against the pan finish.” Current systems may require specialty equipment and ovens which can be expensive, require a facility to house the equipment, and the staff to operate and maintain the equipment.

As can be seen, there is a need for a method of making a serving dish made of baked cookie which does not require specialty machinery.

### SUMMARY OF THE INVENTION

In one aspect of the present invention, a method of making an edible bowl includes forming a dough into a disk; cooling the disk of dough so that the disk generally maintains its shape; placing the disk on a mold; and baking the disk and mold, so that some of the dough flows down the sides of the mold, thereby forming a bowl.

In another aspect of the present invention, a method of making an edible dish includes providing a cookie dough; forming the dough into a generally circular disk; cooling the disk of dough so that the disk will generally maintain a circular shape at room temperature for a short period of time; providing a mold in the general shape of a bowl; while the disk still maintains its shape, placing the disk on the mold and baking the disk and mold; allowing the dough to flow down the sides of the mold, thereby forming an edible dish; allowing the dish to cool; and removing the dish from the mold.

In yet another aspect of the present invention, a system for making an edible dish includes a mold in the shape of a bowl, the mold having an upper portion and a lower portion; and a disk of dough, larger than the upper portion of the mold, shaped so that when the disk is placed on the mold, and then the dough and mold are baked, the dough will flow down the sides of the mold.

### BRIEF DESCRIPTION OF THE DRAWINGS

FIG. 1 depicts a flowchart of an embodiment of the present invention;

FIG. 2 depicts an embodiment of a frozen portion of dough formed into a disk according to the present invention;

FIG. 3 depicts an embodiment of a mold according to the present invention;

FIG. 4 depicts an embodiment of a disk placed on the mold in preparation for baking according to the present invention;

FIG. 5 depicts an embodiment of heated dough freely flowing down the sides of the mold according to the present invention;

FIG. 6 depicts an embodiment of dough firming up, taking on the shape of an inverted bowl, and cooling prior to removal from the mold according to the present invention; and

FIG. 7 depicts an embodiment of finished product removed from the mold according to the present invention.

### DETAILED DESCRIPTION OF THE INVENTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

Broadly, an embodiment of the present invention generally provides a technique and mold readily and economically available to all individuals, businesses and manufacturers.

An embodiment of a method for making cookie bowls may utilize a mold that can be used in an oven and a produces a desirable and familiar cookie with a top and bottom. The bottom or interior of the bowl may have a flattened baked-against-a-pan finish and the top or exterior of the bowl may have a puffy finish like that of a home baked cookie that naturally varies when baked. This home baked appearance may be desirable and appealing to consumers. This method may utilize a simple mold that can be used in a residential or commercial oven and may be used by a novice or commercial baker. The method may avoid the need for expensive specialty equipment or maintenance and may be performed by the average person.

An embodiment of the invention may include a process and molds that may be provided to a consumer or business wishing to produce an edible serving dish composed of a baked cookie using the baking methods, equipment, and ingredients available to most households, food service businesses, and manufacturers. The mold may be made with materials including silicone. Other ingredients and tools may typically be found in a kitchen, bakery, or other food preparation location.

An embodiment of the present invention may include a dough made with the following exemplary ingredients:

| | | |
|---|---|---|
| Ingredient | Amount | as % |

| | | | |
|---|---|---|---|
| butter or shortening (¼ cup = 113 g) | 113 | g | 17% |
| sugar | 110 | g | 17% |
| brown sugar | 60 | g | 9% |
| egg (1 egg = 55 g) | 55 | g | 8% |
| vanilla (½ tsp = 0.0104 cups | 0.01 | cups | 0% |
| water (2 tbsp = ⅛ cup) | 0.125 | cups | 0% |
| flour | 220 | g | 33% |
| salt (½ tsp = 3 g) | 3 | g | 0% |
| baking soda (½ tsp = 2.5 g) | 2.5 | g | 0% |
| particulate (chocolate chips for example) | 95 | g | 14% |
| total weight | 658.635 | | 100% |

These example weights and percentages may produce enough dough for a small batch of cookie bowls. The ingredients could be scaled down to produce a single bowl, or scaled up to produce a larger batch. The ingredients may be modified to taste. For example, the egg may be approximately 38 grams.

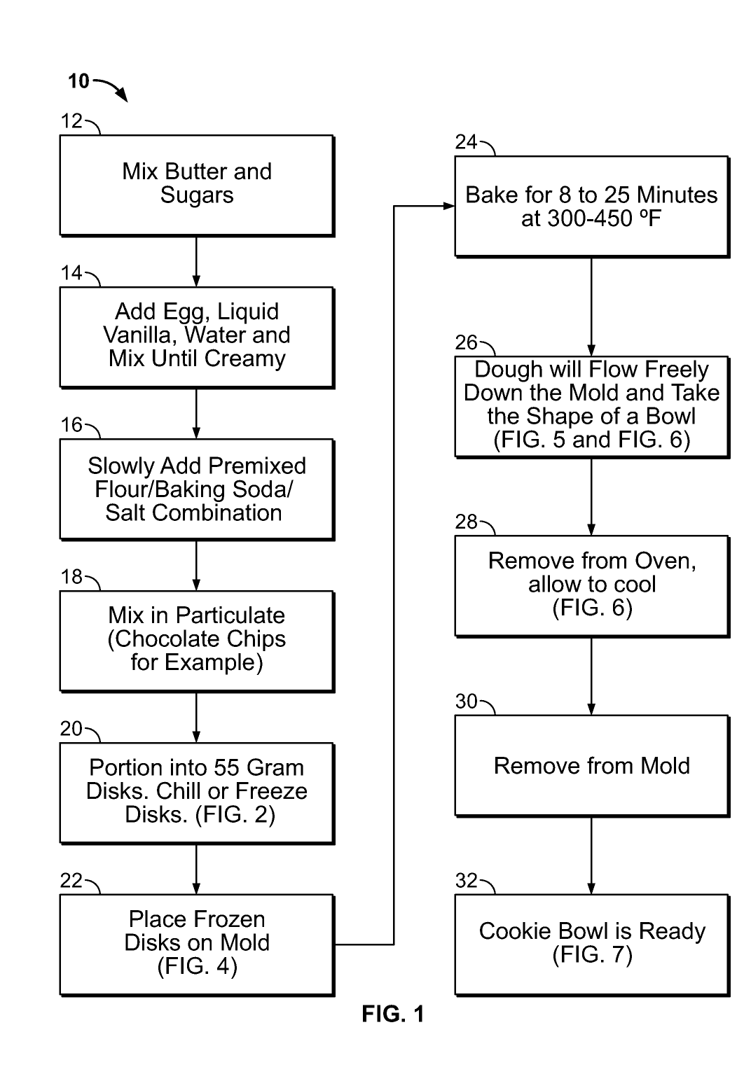

As depicted in FIG. 1, an embodiment of a method 10 for making a cookie bowl may use a mold as follows. Mix butter/shortening and sugars 12. Add egg, liquid vanilla, water and mix until creamy 14. Slowly add a premixed combination of flour, baking soda, salt 16, to provide a dough. Mix in a particulate 18, such as chocolate chips. Steps 12, 14, 16, and 18 may be performed in another order or in conjunction with other steps to prepare a dough. Portion the dough into approximately 55 gram disks and freeze the disks 20. Place the frozen disks of dough on the mold 22, so that each disk takes the shape of a bowl. Bake the dough and molds 24 for 8 to 12 minutes at 300 to 450° F. This may be done, for example, in a convection oven or a conventional oven, and time and temperature may vary. The dough will flow freely down the mold 26 and take the shape of a bowl. Remove the bowls from the oven 28, and allow the bowls to cool. Cooling may take, for example, from 8 to 12 minutes. Remove the bowls from the molds 30 to provide cookie bowls 32.

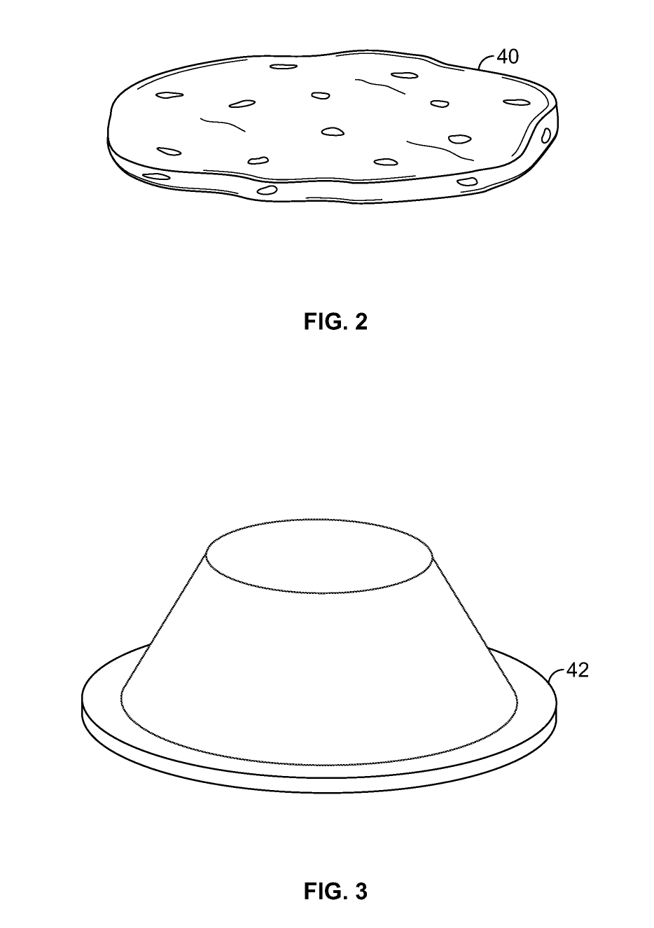

FIG. 2 depicts an embodiment of a frozen disk of dough 40. The cookie dough 40 may be portioned into 30 to 100 gram units in the form of a flattened dough disk ranging from 3 mm to 10 mm in thickness. The dough should be chilled or frozen to such a temperature that it maintains its shape firmly at room temperature for a short time.

FIG. 3 depicts an embodiment of a mold 42, which may form the shape of an inverted bowl with sloped sides. The bowl may have a circular upper portion (top) and a circular lower portion (bottom), the lower portion bigger than the upper portion (having a larger diameter), with the bowl having sloping sides to connect the top and bottom. The top of the mold may be between 3 and 10 centimeters and the base of the mold may be between 3 and 10 centimeters. The height of the mold may be between 3 and 10 centimeters. The mold may be composed of silicone, paper, polymers, plastic, metal alloy or other rigid material suitable for baking.

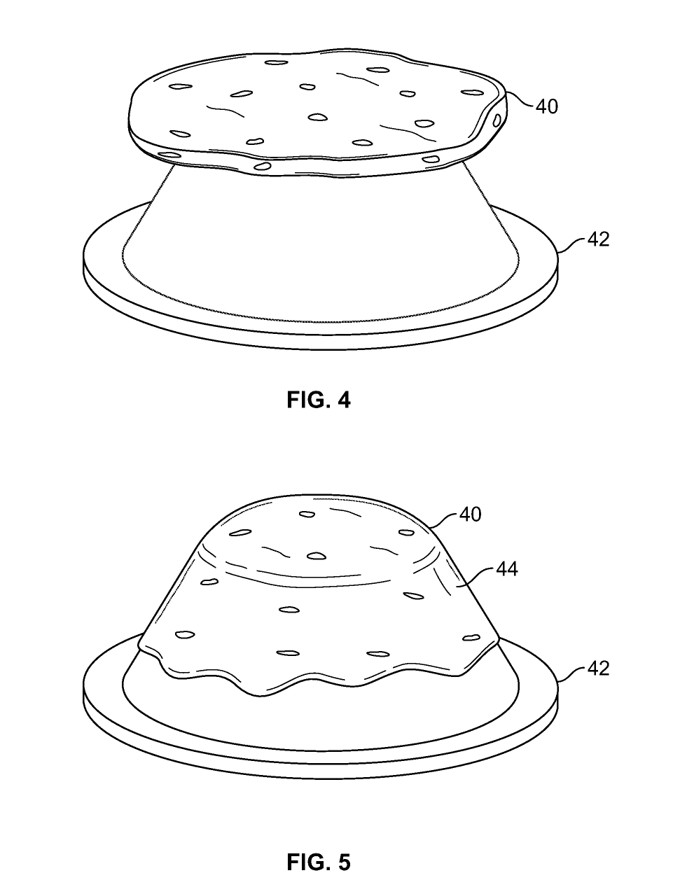

One may place the flattened dough 40 unit onto the mold 42, as depicted in FIG. 4. One may bake the assembly of the mold with dough on top for 8 to 25 minutes in an oven or other baking apparatus at 300 to 450 degrees Fahrenheit.

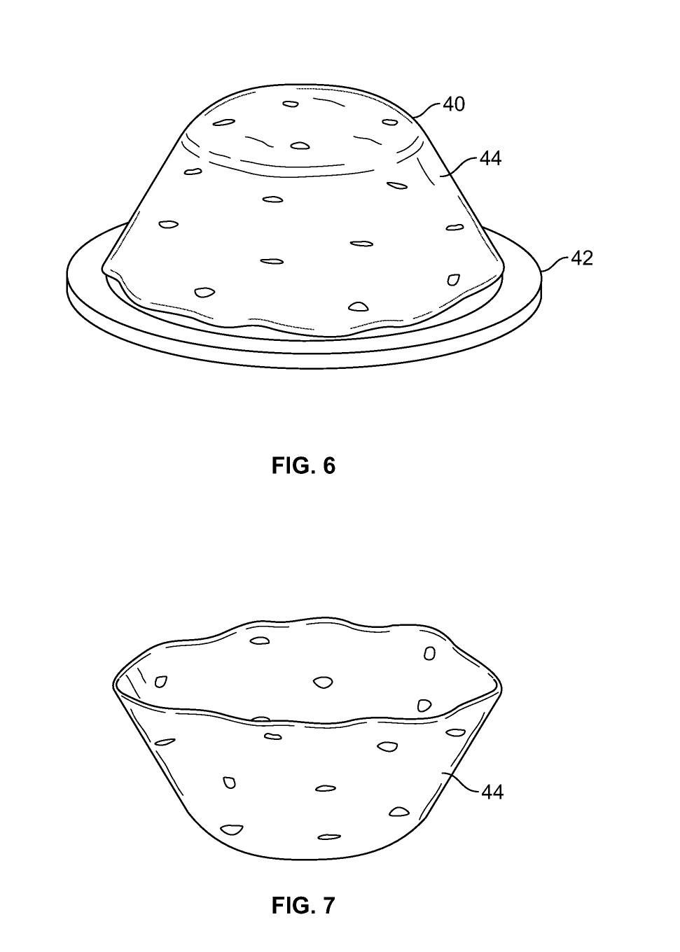

As depicted in FIGS. 5 and 6, the dough 40 may freely flow down the sides of the mold 42 and then firm up to form around the mold as an inverted bowl shaped baked cookie 44. Remove the assembly from the heat and allow the assembly to cool to such a temperature that the baked dough can be easily removed from the mold.

As depicted in FIG. 7, the result may be a serving dish composed of a baked cookie 44 that can be used to serve ice cream or other novelty treats.

An embodiment of the mold may be used as a single unit or combined to create sheets of multiple molds. The molds could also be formed of and integrated with a conveyor system used in certain food manufacturing systems and machines. The dough may be chilled or frozen either prior to or after forming the dough into portioned disks.

An embodiment includes a mold and provides a method for the dough to take on the desired shape. The ingredient percentages allow the finished product to be firm enough to maintain its shape and fluid enough to freely flow over the mold.

To make an embodiment of the invention, machines may mix dough, portion dough, place the dough onto the mold(s), and move the dough into and out of the baking apparatus. Machines may perform some or all of these steps and one or more machine can be used to perform some or all of the steps. The molds could also be used to form bowls composed of confectionary, candy, cakes, and other edible products. The process may produce an edible bowl or dish suitable for serving foods or presenting tokens and gifts.

A method of making a cookie may include: preparing dough; portioning the dough into 30 to 100 gram units in the form of a flattened dough disks ranging from 3 mm to 10 mm in thickness; chilling the dough to such a temperature that it maintains its shape at room temperature; placing the flattened dough on an inverted bowl having sloped sides; and baking the assembly of the bowl with dough for 8 to 25 minutes at 300 to 450 degrees. The dough may flow down the sides of the bowl so as to form an inverted bowl-shaped baked cookie.

I claim:

1. A method of making an edible bowl, comprising:
forming a dough into a disk;
cooling the disk of dough so that the disk generally maintains its shape;
placing the disk on a mold; and
baking the disk and mold, so that some of the dough flows down the sides of the mold, thereby forming a bowl.

2. The method of claim 1, wherein the mold has an upper portion and a lower portion, the lower portion wider than the upper portion, and the disk of dough is larger than the upper portion, so that parts of the disk that extend beyond the upper portion flow down the sides of the mold when the disk is baked.

3. The method of claim 1, further comprising:
allowing the dough to cool; and
removing the dough from the mold.

4. The method of claim 1, further comprising:
portioning the dough into 30 to 100 gram disks, which are from 3 mm to 10 mm in thickness.

5. The method of claim 1, further comprising:
baking the disk and mold for 8 to 25 minutes at 300 to 450 degrees Fahrenheit.

6. The method of claim 1, wherein a top of the mold is between 3 and 10 centimeters, a base of the mold is between 3 and 10 centimeters, and the height of the mold is between 3 and 10 centimeters.

7. A method of making an edible dish, comprising:
providing a cookie dough;
forming the dough into a generally circular disk;
cooling the disk of dough so that the disk will generally maintain a circular shape at room temperature for a short period of time;
providing a mold in the general shape of a bowl;
while the disk still maintains its shape, placing the disk on the mold and baking the disk and mold;
allowing the dough to flow down the sides of the mold, thereby forming an edible dish;
allowing the dish to cool; and
removing the dish from the mold.

8. The method of claim 7, wherein the disk of dough is from 3 mm to 10 mm in thickness.

9. The method of claim 7, wherein the disk is baked for 8 to 25 minutes at 300 to 450 degrees Fahrenheit, thereby allowing the dough to flow down the sides of the mold and form a cookie bowl.

10. A system for making an edible dish, comprising:
a mold in the shape of a bowl, the mold having an upper portion and a lower portion; and
a disk of dough, larger than the upper portion of the mold, shaped so that when the disk is placed on the mold, and then the dough and mold are baked, the dough will flow down the sides of the mold.

11. The system of claim 10, wherein the disk of dough is cooled or frozen so that the disk generally maintains its shape.

12. The system of claim 10, wherein the disk of dough weighs from 30 to 100 grams, and the disk is from 3 mm to 10 mm in thickness.

13. The method of claim 10, wherein a top of the dish is between 3 and 10 centimeters, a base of the dish is between 3 and 10 centimeters, and the height of the dish is between 3 and 10 centimeters.
